(19) United States
(12) Patent Application Publication
(10) Pub. No.: US 2006/0022902 A1
(43) Pub. Date: Feb. 2, 2006

(54) Display device

(75) Inventor: Yuichi Sakai, Yamanashi-ken (JP)

Correspondence Address: SUGHRUE MION, PLLC, 2100 PENNSYLVANIA AVENUE, N.W., SUITE 800, WASHINGTON, DC, 20037, US

(73) Assignee: PIONEER CORPORATION

(21) Appl. No.: 11/185,972

(22) Filed: Jul. 21, 2005

(30) Foreign Application Priority Data
Jul. 28, 2004 (JP) 2004-220135

(51) Int. Cl. G09G 3/28

(52) U.S. Cl. 345/60

(57) ABSTRACT

A display device with which the various drive conditions can be improved in driving a display panel. A driver that drives first row electrode lines disposed at even-numbered locations and second row electrode lines disposed at odd-numbered locations among a plurality of first and second row electrode lines that constitute display lines in a display panel is mounted on one side of the display panel, and a driver that drives first row electrode lines disposed at odd-numbered locations and second row electrode lines disposed at even-numbered locations is mounted on the other side of the display panel. The reset discharge induced in each of the pixel cells belonging to the first and second row electrode lines disposed at odd-numbered locations, and the reset discharge induced in each of the pixel cells belonging to the first and second row electrode lines disposed at even-numbered locations are executed at different times.

### BACKGROUND OF THE INVENTION

1. Field of the Invention

The present invention relates to a display device equipped with a display panel.

2. Description of the Related Art

Plasma display devices equipped with a plasma display panel (hereinafter referred to as PDP) as a large, thin, color display panel are now commercially available.

A PDP comprises a front glass substrate, which serves as the screen, and a back substrate, which are disposed facing each other across a discharge gap filled with a discharge gas. A plurality of band-shaped row electrodes extending in the row direction on the screen are formed on the inside of the glass substrate (the side across from the back substrate). A plurality of band-shaped column electrodes extending in the column direction on the screen are formed on the back substrate. A pair of adjacent row electrodes (hereinafter referred to as a row electrode pair) constitutes one display line. A discharge cell that serves as a pixel is formed at the intersection of each row electrode pair and column electrode.

Such a PDP is further provided with a row electrode driver for applying various drive pulses (discussed below) to the row electrodes, and an address driver for applying pixel data pulses corresponding to an input video signal to the column electrodes.

The row electrode driver first subjects all the discharge cells to reset discharge by applying reset pulses to all of the row electrode pairs at once. This reset discharge forms a wall charge inside all the discharge cells. Next, the address driver applies a plurality of pixel data pulses corresponding to the display lines to each of the column electrodes for each display line. During this time the row electrode driver sequentially applies to one of the row electrodes of the row electrode pairs the scan pulses to be discharged on the basis of the above-mentioned pixel data pulses. In discharge cells in which high-voltage pixel data pulses and scan pulses have been applied simultaneously, address discharge is selectively induced and any wall charge remaining in the discharge cells is erased. The row electrode driver then applies sustain pulses alternately and repeatedly to each of the row electrodes in all of the row electrode pairs. In this process only those discharge cells with a remaining wall charge undergo sustain discharge every time the above-mentioned sustain pulses are applied, and the light emission accompanying this sustain discharge produces an image corresponding to the input video signal on the screen side of the front glass substrate.

A problem with performing drive as above, however, was the decrease in the contrast of the displayed image resulting from discharge accompanying light emission which did not contribute to the displayed image, such as The above-mentioned reset discharge and address discharge.

In view of this, a PDP was proposed in which light emission entailing the above-mentioned reset discharge and address discharge was suppressed in an effort to improve the contrast of the displayed image (see, for example, Japanese Patent Kokai No. 2003-86108 (Patent Document 1)).

FIG. 1 is a view of a part of this PDP from the display side (see FIG. 1 of Patent Document 1). FIG. 2 is a cross section along the V1-V1 line in the display panel shown in FIG. 1 (see FIG. 2 of Patent Document 1).

With the PDP shown in FIG. 1, each discharge cell is made up of a display and discharge cell C1 that induces only sustain discharge, and a reset and address discharge cell C2 that induces reset discharge and address discharge that do not contribute to the displayed image. A black or dark brown light absorption layer 18 is formed in the reset and address discharge cell C2 in order to prevent the light emission accompanying the discharge induced in the reset and address discharge cell C2 from be radiated to the screen side.

Therefore, with a PDP having the structure shown in FIGS. 1 and 2, there is a major reduction in the amount of leakage of light emission accompanying reset discharge and address discharge to the screen side, so the contrast of the displayed image can be increased.

However, with a PDP such as this, the row electrode X belonging to the display and discharge cell C1 in each discharge cell is shared as the row electrode X belonging to the reset and address discharge cell C2 in the discharge cell that is adjacent in the upward direction of the former discharge cell. Thus, the discharge cells belonging to odd-numbered display lines must be driven at a different timing from that of discharge cells belonging to even-numbered display lines.

In view of this, to drive such a PDP, four electrode drivers are used as shown in FIG. 3 in addition to the address driver that drives the column electrodes.

In FIG. 3, an odd-numbered X discharge driver XDo applies reset pulses or sustain pulses to each of the row electrodes X₁, X₃, X₅, . . . , Xₙ₋₁ belonging to the odd-numbered display lines of a PDP having the structure shown in FIGS. 1 and 2. An even-numbered X discharge driver XDe applies reset pulses or sustain pulses to each of the row electrodes X₀, X₂, X₄, . . . , Xₙ belonging to the even-numbered display lines of this PDP. An odd-numbered Y discharge driver YDo applies reset pulses, scan pulses, or sustain pulses to each of the row electrodes Y₁, Y₃, Y₅, . . . , Yₙ₋₁ belonging to the odd-numbered display lines of the PDP. An even-numbered Y discharge driver YDe applies reset pulses or sustain pulses to each of the row electrodes Y₂, Y₄, . . . , Yₙ belonging to the even-numbered display lines of this PDP.

Therefore, the problem with the mode shown in FIG. 3 is that when the odd-numbered X discharge driver XDo, the even-numbered X discharge driver XDe, the odd-numbered Y discharge driver YDo, and the even-numbered Y discharge driver YDe are each disposed near the PDP, and the drivers and row electrodes are connected, the wiring ends up being complicated.

Also, since high-voltage reset pulses or sustain pulses are applied between the takeoff electrodes of the row electrodes Y₁, Y₃, Y₅, . . . , Yₙ₋₁ belonging to the odd-numbered display lines and the takeoff electrodes of the row electrodes Y₂, Y₄, . . . , Yₙ belonging to the even-numbered display lines, there is the danger of encountering problems such as inadequate voltage resistance or migration between takeoff electrodes. Furthermore, since there is stray capacity in the wiring connecting each of the drivers to the takeoff electrode terminals, another problem is that reactive charging and discharging occur with respect to this stray capacity, which increases the amount of reactive power.

The present invention was conceived in an effort to solve these problems, and it is an object thereof to provide a display device with which the various drive conditions can be improved in driving a display panel.

### SUMMARY OF THE INVENTION

The display device pertaining to the present invention is a display device comprising a display panel having formed therein a plurality of first and second row electrode lines disposed alternately and each extending in the horizontal direction of a display screen between a pair of substrates disposed across from each other with a discharge space therebetween, a plurality of column electrode lines disposed so as to intersect the first and second row electrode lines, and pixel cells for carrying pixels, provided at the intersections between the first and second row electrode lines and the column electrode lines, wherein the display device comprises a reset component for initializing the state of each of the pixel cells by inducing a reset discharge in all of the pixel cells, an address component for setting each of the pixel cells to either a flashing mode or an unlit mode by selectively subjecting the pixel cells to address discharge by sequentially applying scanning pulses to each of the first row electrode lines and applying pixel data pulses corresponding to input video signals to the column electrode lines, and a sustain component for subjecting only those pixel cells that are in the flashing mode to sustain discharge by applying sustain pulses to the first row electrode lines or the second row electrode lines, a plurality of first connection terminals connected individually to each of the first row electrode lines disposed at odd-numbered locations among the first row electrode lines, and a single second connection terminal connected in common to each of the second row electrode lines disposed at even-numbered locations among the second row electrode lines are provided in the vicinity of one side of the display panel, and a plurality of third connection terminals connected individually to each of the first row electrode lines disposed at even-numbered locations among the first row electrode lines, and a single fourth connection terminal connected in common to each of the second row electrode lines disposed at odd-numbered locations among the second row electrode lines are provided in the vicinity of the other side of the display panel, the address component includes a first scan driver for sequentially applying the scan pulses to each of the first connection terminals, and a second scan driver for sequentially applying the scan pulses to each of the third connection terminals, the sustain component includes a first sustain driver for simultaneously applying the sustain pulses to the first connection terminals and the second connection terminal, and a second sustain driver for simultaneously applying the sustain pulses to the third connection terminals and the fourth connection terminal, the reset component includes a first reset driver for simultaneously applying first reset pulses having a first polarity or second reset pulses having a second polarity different from the first polarity to each of the second row electrode lines disposed at even-numbered locations, and simultaneously applying third reset pulses having a pulse voltage that is higher by a specific voltage than the voltage of the first reset pulses, or fourth reset pulses having a pulse voltage that is higher by a specific voltage than the voltage of the second reset pulses to each of the first row electrode lines disposed at odd-numbered locations, and a second reset driver for simultaneously applying the second reset pulses or the first reset pulses to each of the second row electrode lines disposed at odd-numbered locations, and simultaneously applying the fourth reset pulses or the third reset pulses to each of the first row electrode lines disposed at even-numbered locations, and the display device further comprises a drive control component for controlling the first and second reset drivers such that the reset discharge induced in each of the pixel cells belonging to the first and second row electrode lines disposed at odd-numbered locations, and the reset discharge induced in each of the pixel cells belonging to the first and second row electrode lines disposed at even-numbered locations are executed at different times.

A driver that drives first row electrode lines disposed at even-numbered locations and second row electrode lines disposed at odd-numbered locations among a plurality of first and second row electrode lines that constitute display lines in a display panel are mounted on one side of the display panel, and a driver that drives first row electrode lines disposed at odd-numbered locations and second row electrode lines disposed at even-numbered locations is mounted on the other side of the display panel. The reset discharge induced in each of the pixel cells belonging to the first and second row electrode lines disposed at odd-numbered locations, and the reset discharge induced in each of the pixel cells belonging to the first and second row electrode lines disposed at even-numbered locations are executed at different times.

### BRIEF DESCRIPTION OF THE DRAWINGS

FIG. 1 is a plan view of part of the structure of a conventional PDP from the screen side;

FIG. 2 is a cross section of the PDP along the V1-V1 line shown in FIG. 1;

FIG. 3 is a diagram of the simplified structure of a conventional plasma display device;

FIG. 4 is a diagram of the simplified structure of the plasma display device pertaining to the present invention;

FIG. 5 is a plan view of part of the structure of a display panel part DPE of the PDP 50 shown in FIG. 4, seen from the screen side;

FIG. 6 is a cross section along the V1-V1 line shown in FIG. 5;

FIG. 7 is a cross section along the V2-V2 line shown in FIG. 5;

FIG. 8 is a cross section along the W1-W1 line shown in FIG. 5;

FIG. 9 is a conversion table of pixel data, and a diagram of light emission drive patterns based on pixel drive data GD obtained for this pixel data conversion table;

FIG. 10 is a diagram of an example of the light emission drive sequence in the plasma display device shown in FIG. 4;

FIG. 11 is a diagram illustrating the various drive pulses applied to the PDP 50 according to the light emission drive sequences shown in FIG. 10, and the timing of this application;

FIG. 12 is a plan view of another structure of the display panel part DPE;

FIG. 13 is a cross section along the V1-V1 line shown in FIG. 12;

FIG. 14 is a cross section along the V2-V2 line shown in FIG. 12;

FIG. 15 is a cross section along the W1-W1 line shown in FIG. 12; and

FIG. 16 is a cross section along the W2-W2 line shown in FIG. 12.

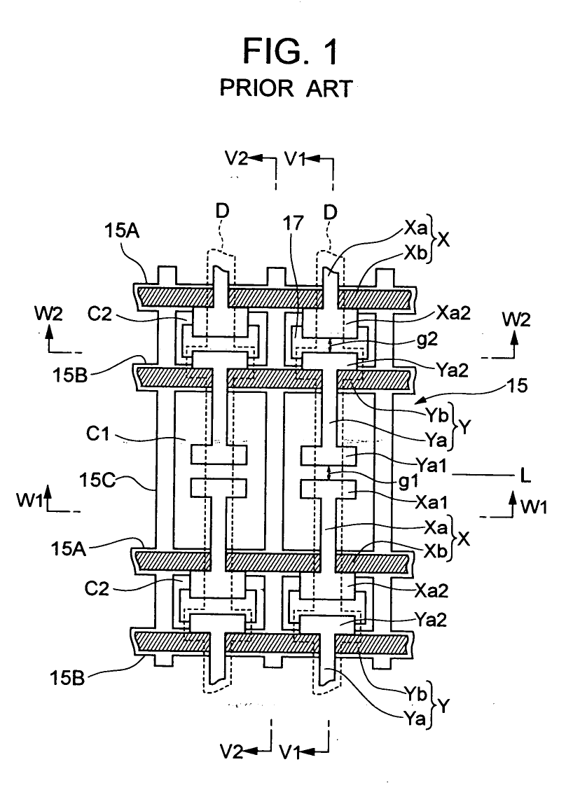

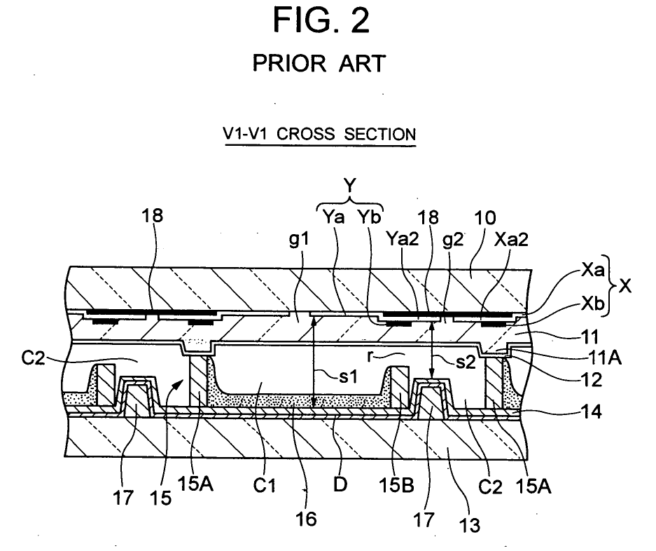

### DETAILED DESCRIPTION OF THE INVENTION

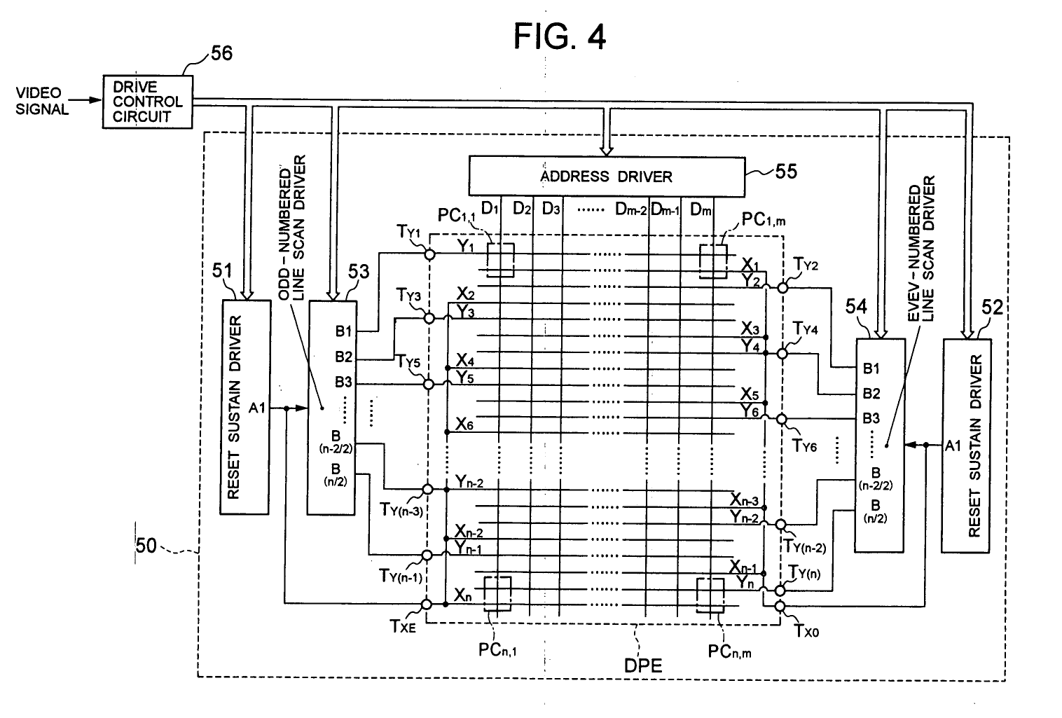

FIG. 4 is a diagram of the structure of a plasma display device, an example of the display device pertaining to the present invention.

As shown in FIG. 4, this plasma display device is made up of a PDP 50 (a plasma display panel) and a drive control circuit 56 that controls the drive of this PDP 50 according to input video signals.

Column electrodes (address electrodes) D₁ to Dₘ in the form of lines extended in the column direction (up and down) of the display screen are formed in the display panel part DPE of the PDP 50. Row electrodes X₁ to Xₙ and row electrodes Y₁ to Yₙ (n is an even number) in the form of lines extending in the row direction (right and left) of the display screen are arranged in numerical order, and alternating between X and Y, on the display panel part DPE. The row electrode pairs here, which each comprise a pair of adjacent electrodes, that is, the row electrode pairs (X₁, Y₁) to (Xₙ, Yₙ), correspond respectively to first to n-th display lines in the PDP 50. Pixel cells PC, which serve as pixels, are formed at the intersections between the various display lines and column electrodes D₁ to Dₘ (the region surrounded by the one-dot chain line in FIG. 4). Specifically, pixel cells PC_{1,1} to PC_{n,m} are formed in the display panel part DPE at positions corresponding to the first row/first column to m-th row/m-th column on the display screen.

Of the row electrodes X₁ to Xₙ, the odd-numbered row electrodes X₁, X₃, X₅, . . . , Xₙ₋₃ and Xₙ₋₁ are connected in common to a single connection terminal T_{XO} provided to the right end of the display panel part DPE. The even-numbered row electrodes X₂, X₄, X₆, . . . , Xₙ₋₂ and Xₙ are connected in common to a single connection terminal T_{XE} provided to the left end of the display panel part DPE. Of the row electrodes Y₁ to Yₙ, the odd-numbered row electrodes Y₁, Y₃, Y₅′ . . . , Yₙ₋₃ and Yₙ₋₁ are connected individually to connection terminals T_{Y1}, T_{Y3}, T_{Y5}, . . . , T_{Y(n-3)} and T_{Y(n-1)}, respectively, provided to the left end of the display panel part DPE. The even-numbered row electrodes Y₂, Y₄, . . . , Yₙ₋₂ and Yₙ are connected individually to connection terminals T_{Y2}, T_{Y4}, . . . , T_{Y(n-2)} and T_{Y(n)}, respectively, provided to the right end of the display panel part DPE.

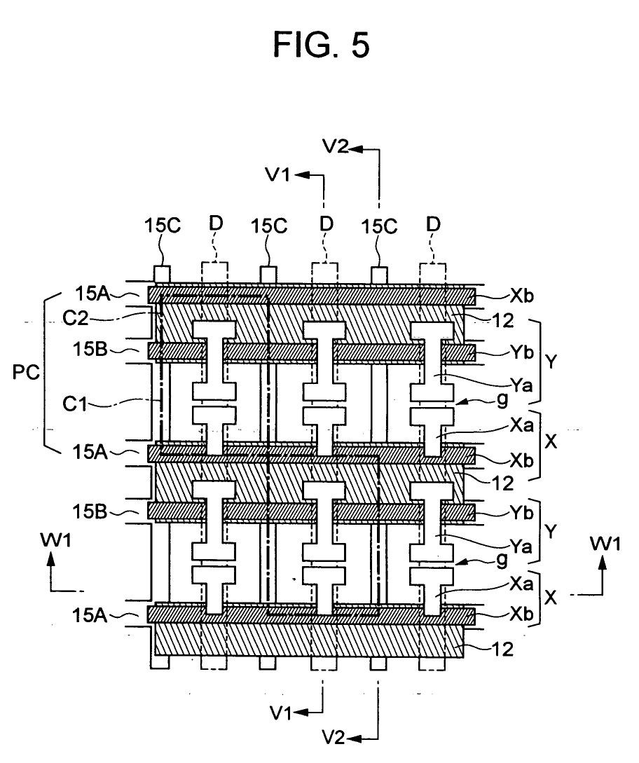

FIGS. 5 to 8 are detail diagrams of part of the internal structure of the above-mentioned display panel part DPE.

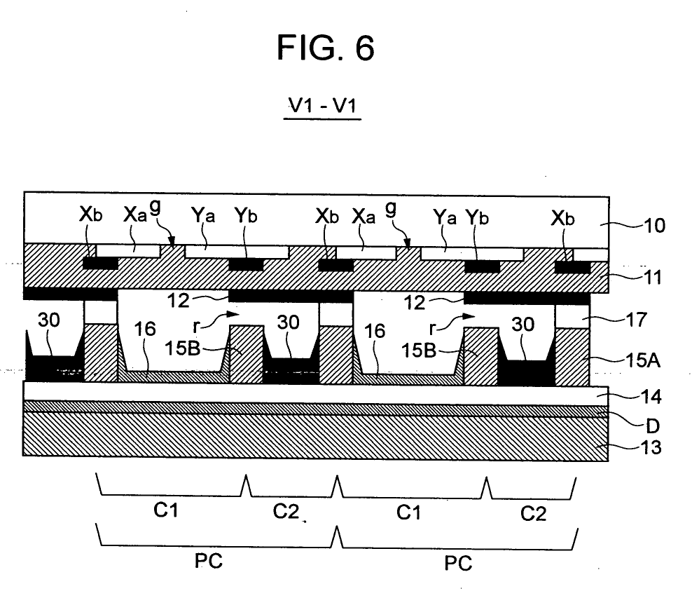

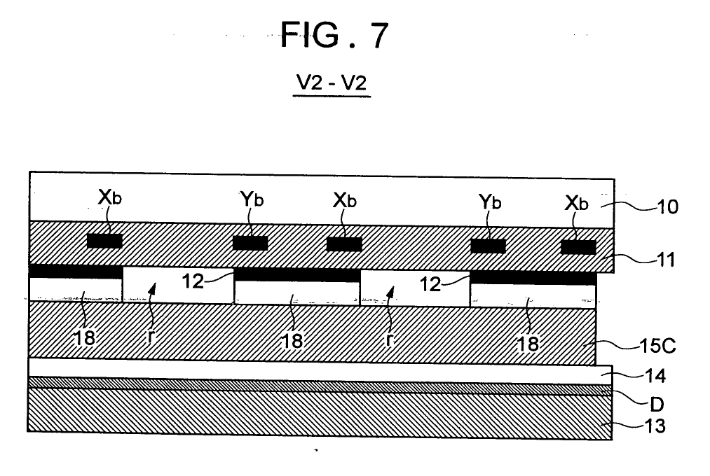

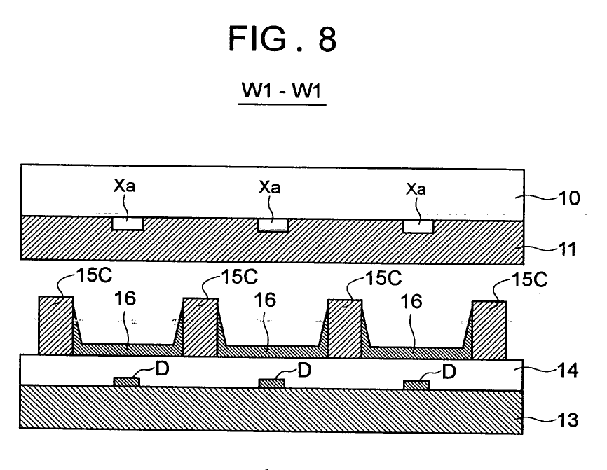

FIG. 5 is a plan view from the screen side, FIG. 6 is a cross section along the V1-V1 line shown in FIG. 5, FIG. 7 is a cross section along the V2-V2 line shown in FIG. 5, and FIG. 8 is a cross section along the W1-W1 line shown in FIG. 5.

As shown in FIG. 5, a row electrode Y is made up of a band-shaped base electrode Yb (the main part of the row electrode Y) extending in the row direction (left and right) of the display screen, and a plurality of transparent electrodes Ya connected to the bus electrode Yb. The bus electrode Yb is composed of a black metal film, for example. The transparent electrodes Ya are composed of a transparent conductive film such as ITO, and are disposed at positions corresponding to the various column electrodes D on the bus electrode Yb. The transparent electrodes Ya extend perpendicular to the bus electrode Yb, and the two ends thereof are formed wider, as shown in FIG. 5. Specifically, the transparent electrodes Ya can be considered to be protruding electrodes that protrude from the main part of the row electrode Y. A row electrode X is made up of a band-shaped bus electrode Xb (the main part of the row electrode X) extending in the row direction (left and right) of the display screen, and a plurality of transparent electrodes Xa connected to the bus electrode Xb. The bus electrode Xb is composed of a black metal film, for example. The transparent electrodes Xa are composed of a transparent conductive film such as ITO, and are disposed at positions corresponding to the various column electrodes D on the bus electrode Xb. The transparent electrodes Xa extend perpendicular to the bus electrode Xb, and one end thereof is formed wider, as shown in FIG. 5. Specifically, the transparent electrodes Xa can be considered to be protruding electrodes that protrude from the main part of the row electrode X. The wider portions of the transparent electrodes Xa and Ya are disposed across from each other via a discharge gap g of a specific width, as shown in FIG. 5. That is, the transparent electrodes Xa and Ya serving as protruding electrodes that protrude from the main parts of the paired electrodes X and Y, respectively, are disposed across from each other via the discharge gap g.

As shown in FIG. 6, row electrodes Y composed of the transparent electrodes Ya and the bus electrode Yb and row electrodes X composed of the transparent electrodes Xa and the bus electrode Xb are formed on the inner side of a transparent substrate 10 serving as the display screen of the PDP 50. Further, a dielectric layer 11 is formed on the back side of the transparent substrate 10 so as to cover these row electrodes X and Y. A padded dielectric layer 12 protruding from the dielectric layer 11 toward the back side is formed at positions corresponding to selection cells C2 (discussed below) on the surface of the dielectric layer 11. The padded dielectric layer 12 is composed of a band-shaped light-absorbent layer containing a black or dark-colored pigment, and is formed extended in the row direction (left and right) on the display screen, as shown in FIG. 5. The surface of the padded dielectric layer 12 and the surface of the dielectric layer 11 where the padded dielectric layer 12 is not formed are covered by a protective layer (not shown) composed of MgO (magnesium oxide). The plurality of column electrodes D extending perpendicular to the bus electrodes Xb and Yb are arranged in parallel, with a specific gap in between them, on a back substrate 13 disposed parallel to the transparent substrate 10. A white column electrode protective layer (dielectric layer) 14 that covers the column electrodes D is formed on the back substrate 13. A partition 15 comprising a first horizontal wall 15A, a second horizontal wall 15B, and a vertical wall 15C is formed on the column electrode protective layer 14. The first horizontal wall 15A is formed extending in the row direction (left and right) of the display screen at a position on the column electrode protective layer 14 across from the bus electrode Yb. The second horizontal wall 15B is formed extending in the row direction (left and right) of the display screen at a position on the column electrode protective layer 14 across from the bus electrode Xb. The vertical wall 15C is formed extending perpendicular to the bus electrode Xb and Yb at positions in between the transparent electrodes Xa and Ya that are equidistantly disposed on the bus electrode Xb and Yb.

As shown in FIG. 6, a secondary electron releasing material layer 30 is formed in the regions (including the side faces of the vertical wall 15C, the first horizontal wall 15A, and the second horizontal wall 15B) across from the padded dielectric layer 12 on the column electrode protective layer 14. The secondary electron releasing material layer 30 is a layer composed of a high-gamma material with a low work function (such as 4.2 eV or less) and a high so-called secondary electron release coefficient. Examples of materials used as the secondary electron releasing material layer 30 include MgO, CaO, SrO, BaO, and other such alkaline earth metal oxides, Cs₂O and other such alkali metal oxides, CaF₂, MgF₂, and other such fluorides, TiO₂, Y₂O₃, materials whose secondary electron release coefficient has been increased by crystal defects or impurity doping, diamond-like thin films, and carbon nanotubes. Meanwhile, as also shown in FIG. 6, a fluorescent layer 16 is formed in the regions including the side faces of the vertical wall 15C, the first horizontal wall 15A, and the second horizontal wall 15B) other than the regions across from the padded dielectric layer 12 on the column electrode protective layer 14. The fluorescent layer 16 comprises three systems: a red fluorescent layer that emits red light, a green fluorescent layer that emits green light, and a blue fluorescent layer that emits blue light, with the proportions thereof being determined for each pixel cell PC. There are discharge spaces filled with a discharge gas between the secondary electron releasing material layer 30 and the fluorescent layer 16 and the dielectric layer 11. As shown in FIGS. 6 and 8, the first horizontal wall 15A, the second horizontal wall 15B, and the vertical wall 15C are each not tall enough to react the surface of the padded dielectric layer 12 or the dielectric layer 11. Therefore, as shown in FIG. 6, a gap r into which discharge gas can flow is present between the second horizontal wall 15B and the dielectric layer 12. A dielectric layer 17 extending along the first horizontal wall 15A is formed between the first horizontal wall 15A and the padded dielectric layer 12 in order to prevent discharge interference. A dielectric layer 18 extending intermittently along the vertical wall 15C is formed as shown in FIG. 7 between the vertical wall 15C and the padded dielectric layer 12.

The regions bounded by the first horizontal wall 15A and the vertical wall 15C here (the regions bounded by the one-dot chain lines in FIG. 5) constitute a pixel cell PC that serves as a pixel. Further, as shown in FIGS. 5 and 6, each pixel cell PC is divided by the second horizontal wall 15B into a display cell C1 and a selection cell C2. The display cell C1 includes the fluorescent layer 16 and a pair of row electrodes X and Y serving as a display line, as shown in FIGS. 5 and 6. The selection cell C2 includes a row electrode Y from among the pair of row electrodes serving as the display line, a row electrode X from among the pair of row electrodes serving as the display line adjacent to (above on the display screen) the above-mentioned display line, the padded dielectric layer 12, and the secondary electron releasing material layer 30. As shown in FIG. 5, within each display cell C1 a wide portion formed at one end of a transparent electrode Xa of the row electrode X and a wide portion formed at one end of the transparent electrode Ya of the row electrode Y are disposed facing each other across the discharge gap g. A wide portion formed at the other end of this transparent electrode Ya is included in the selection cell C2, but not in the transparent electrode X.

Also, as shown in FIG. 6, the discharge spaces of each of the pixel cells PC adjacent to each other in the vertical direction of the display screen (the left and right direction in FIG. 6) are blocked off by the first horizontal wall 15A and the dielectric layer 17. The discharge spaces of each of the display cell C1 and the selection cell C2 belonging to a given pixel cell PC communicate through the gap r as shown in FIG. 6. Also, the discharge spaces of each of the selection cells C2 adjacent to each other in the left and right direction of the display screen are blocked off by the padded dielectric layer 12 and the dielectric layer 18 as shown in FIG. 7, but the discharge spaces of each of the display cells C1 adjacent to each other in the left and right direction of the display screen communicate with each other. Thus, each of the pixel cells PC formed in the display panel part DPE comprises a display cell C1 and a selection cell C2 whose discharge spaces communicate with each other.

As shown in FIG. 4, an address driver 55 is mounted near the upper end of the display panel part DPE on the chassis (not shown) supporting the display panel part DPE.

Also, as shown in FIG. 4, a reset sustain driver 51 and an odd-numbered line scan driver 53 are mounted near the left end of the display panel part DPE on this chassis. An output terminal A1 of the reset sustain driver 51 is electrically connected to a connection terminal T_{XE} of the display panel part DPE and the odd-numbered line scan driver 53. Output terminals B1, B2, B3, . . . , B((n−2)/2), and B(n/2) of the odd-numbered line scan driver 53 are electrically connected to connection terminals T_{Y1}, T_{Y3}, T_{Y5}, . . . , T_{Y(n-3)}, and T_{Y(n-1)}, respectively, of the display panel part DPE via a single connection line.

A reset sustain driver 52 and an even-numbered scan line driver 54 are mounted near the right end of the display panel part DPE on the chassis. An output terminal A1 of the reset sustain driver 52 is electrically connected to a connection terminal T_{XO} of the display panel part DPE and the even-numbered line scan driver 54. Output terminals B1, B2, B3, . . . , B((n−2)/2), and B(n/2) of the even-numbered line scan driver 54 are electrically connected to connection terminals T_{Y2}, T_{Y4}, . . . , T_{Y(n-2)}, and T_{Y(n)}, respectively, of the display panel part DPE via a single connection line.

The reset sustain driver 51 generates various drive pulses (discussed below) according to timing signals supplied from the drive control circuit 56, and the generated drive pulses are outputted from the output terminal A1. Specifically, the various drive pulses outputted from the reset sustain driver 51 are supplied to the odd-numbered line scan driver 53, and are applied to the corresponding even-numbered row electrodes X₂, X₄, X₆, . . . , Xₙ₋₂ and Xₙ via the connection terminal T_{XE} of the display panel part DPE.

The odd-numbered line scan driver 53 outputs the drive pulses supplied from the reset sustain driver 51 from the output terminals B1, B2, B3, . . . , B((n−2)/2), B(n/2). However, when a reset pulse (discussed below) is supplied from the reset sustain driver 51, the odd-numbered line scan driver 53 outputs reset pulses (discussed below) obtained by shifting this entire reset pulse by a specific voltage Vₕ to the positive potential side, from the output terminals B1, B2, B3, . . . , B((n−2)/2), B(n/2). The odd-numbered line scan driver 53 also generates scanning pulses (discussed below) according to timing signals supplied from the drive control circuit 56, and these are sequentially outputted one at a time from the output terminals B1, B2, B3, . . . , B((n−2)/2), B(n/2).

Specifically, the various drive pulses outputted from the odd-numbered line scan driver 53 are applied to the odd-numbered row electrodes Y₁, Y₃, Y₅, . . . , Yₙ₋₃, and Yₙ₋₁ via the connection terminals T_{Y1}, T_{Y3}, T_{Y5}, . . . , T_{Y(n-3)} and T_{Y(n-1)}, respectively, of the display panel part DPE.

The reset sustain driver 52 generates various drive pulses (discussed below) according to timing signals supplied from the drive control circuit 56, and the generated drive pulses are outputted from the output terminal A1. Specifically, the various drive pulses outputted from the reset sustain driver 52 are supplied to the even-numbered line scan driver 54, and are applied to the corresponding odd-numbered row electrodes X₁, X₃, X₅, . . . Xₙ₋₃ and Xₙ₋₁ via the connection terminal T_{XO} of the display panel part DPE.

The even-numbered line scan driver 54 outputs the drive pulses supplied from the reset sustain driver 52 from the output terminals B1, B2, B3, . . . , B((n−2)/2), B(n/2). However, when a reset pulse (discussed below) is supplied from the reset sustain driver 52, the even-numbered line scan driver 54 outputs reset pulses (discussed below) obtained by shifting this entire reset pulse by a specific voltage Vₕ to the positive potential side, from the output terminals B1, B2, B3, . . . , B((n−2)/2), B(n/2). The even-numbered line scan driver 54 also generates scanning pulses (discussed below) according to timing signals supplied from the drive control circuit 56, and these are sequentially outputted one at a time from the output terminals B1, B2, B3, . . . , B((n−2)/2), B(n/2).

Specifically, the various drive pulses outputted from the even-numbered line scan driver 54 are applied to the even-numbered row electrodes Y₂, Y₄, . . . , Yₙ₋₂, and Yₙ via the connection terminals T_{Y2}, T_{Y4}, . . . , T_{Y(n-2)} and T_{Y(n)}, respectively, of the display panel part DPE.

The address driver 55 applies pixel data pulses (discussed below) to the column electrodes D₁ to Dₘ of the PDP 50 according to timing signals supplied from the drive control circuit 56.

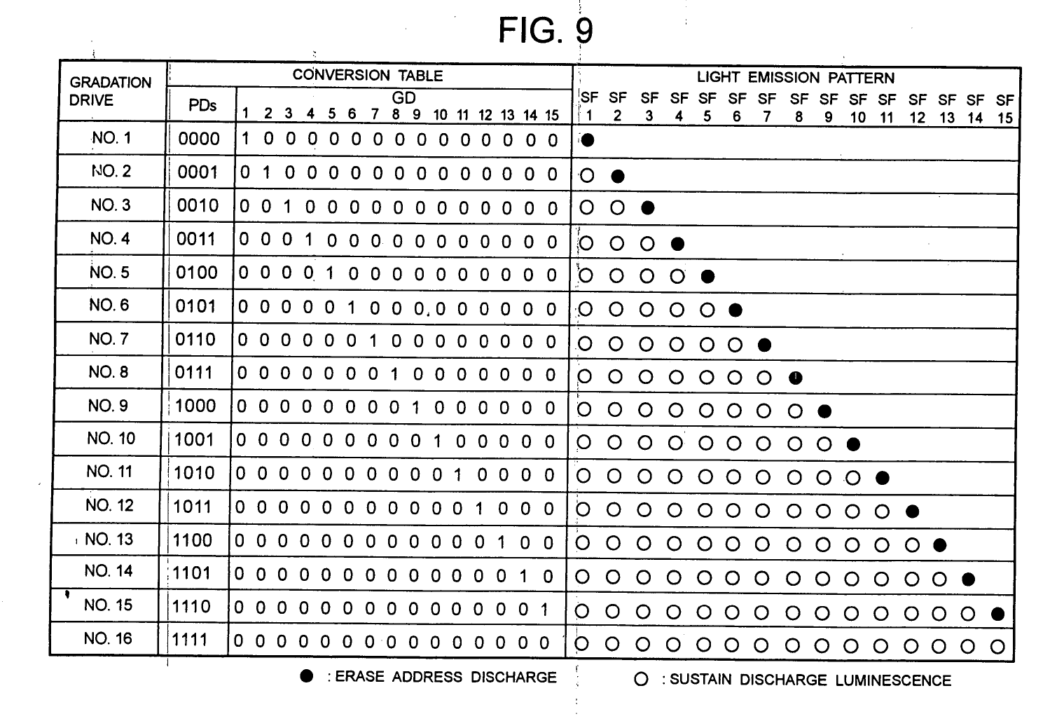

The drive control circuit 56 first converts an input video signal into 8-bit (for example) pixel data expressing the brightness level for every pixel, and subjects this pixel data to error expansion processing and dither processing. For example, in this error expansion processing, first the highest 6 bits of pixel data are converted into display data, and the remaining lower two bits into error data. The weighted addition of each piece of error data of this pixel data corresponding to surrounding pixels is reflected in the above-mentioned display data. The result of this operation is that the brightness of the lower two bits of the original pixel is simulated by the above-mentioned surrounding pixels, and consequently it is possible to express the same brightness gradation as that of the above-mentioned 8 bits of pixel data with just 6 bits of display data. The 6-bit error expanded pixel data obtained by this error expansion processing is then subjected to dithering. In this dither processing, a plurality of adjacent pixels are grouped as one pixel unit, and dither factors composed of mutually different factor values are allocated and added to the above-mentioned error expanded pixel data corresponding to each pixel in this pixel unit, which gives dither added pixel data. This addition of dither factors makes it possible to express brightness corresponding to 8 bits with just the highest 4 bits of the above-mentioned dither added pixel data when the above-mentioned pixel unit is viewed. In view of this, the drive control circuit 56 terms the highest 4 bits of the dither added pixel data as multi-graded pixel data PDs, and converts this into 15-bit pixel drive data GD composed of first to fifteenth bits according the data conversion table in FIG. 9. Therefore, pixel data capable of expressing 256 gradations with 8 bits is converted into 15-bit pixel drive data GD composed of a total of 16 patterns as shown in FIG. 9. Next, the drive control circuit 56 separates the pixel drive data GD_{1,1} to GD_{n,m} by same-bit digits for each of the pixel drive data GD_{1,1} to GD_{n,m} in one screen, thereby obtaining pixel drive data bit groups DB1 to DB15 as follows.
DB1: first bits of pixel drive data GD_{1,1} to GD_{n,m}
DB2: second bits of pixel drive data GD_{1,1} to GD_{n,m}
DB3: third bits of pixel drive data GD_{1,1} to GD_{n,m}
DB4: fourth bits of pixel drive data GD_{1,1} to GD_{n,m}
DB5: fifth bits of pixel drive data GD_{1,1} to GD_{n,m}
DB6: sixth bits of pixel drive data GD_{1,1} to GD_{n,m}
DB7: seventh bits of pixel drive data GD_{1,1} to GD_{n,m}
DB8: eighth bits of pixel drive data GD_{1,1} to GD_{n,m}
DB9: ninth bits of pixel drive data GD_{1,1} to GD_{n,m}
DB10: tenth bits of pixel drive data GD_{1,1} to GD_{n,m}
DB11: eleventh bits of pixel drive data GD_{1,1} to GD_{n,m}
DB12: twelfth bits of pixel drive data GD_{1,1} to GD_{n,m}
DB13: thirteenth bits of pixel drive data GD_{1,1} to GD_{n,m}
DB14: fourteenth bits of pixel drive data GD_{1,1} to GD_{n,m}
DB15: fifteenth bits of pixel drive data GD_{1,1} to GD_{n,m}

The pixel drive data bit groups DB1 to DB15 respectively correspond to sub-fields SF1 to SF15 (discussed below). The drive control circuit 56 supplies a pixel drive data bit group DB corresponding to each of the sub-fields SF1 to SF15 to the address driver 55 one display line at a time (for m number of lines).

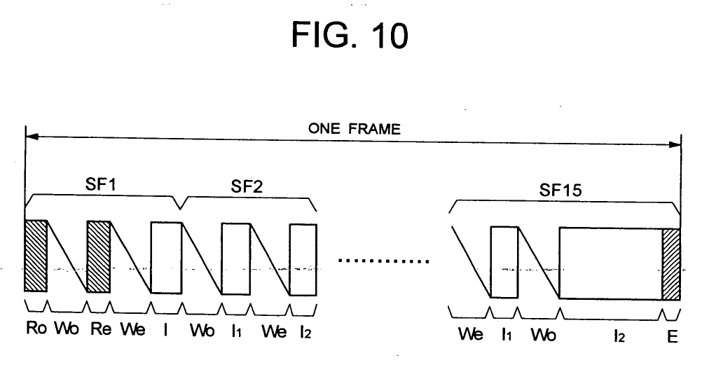

Further, the drive control circuit 56 generates various timing signals in order to control the drive of the PDP 50 according to the light emission drive sequence based on the selective erasure address method shown in FIG. 10, and supplies these timing signals to the reset sustain drivers 51 and 52, the odd-numbered line scan driver 53, the even-numbered scan line driver 54, and the address driver 55.

With the light emission driven sequence shown in FIG. 10, the display of a single frame is divided into the 15 sub-fields SF1 to SF15.

In the first sub-field SF1, an odd-numbered line reset step R_{O}, an odd-numbered line address step W_{O}, an even-numbered line reset step R_{E}, an even-numbered line address step W_{E}, and a sustain step I are executed sequentially. In each of sub-fields SF2 to SF15 following SF1, an odd-numbered line address step W_{O}, the sustain step I₁, the even-numbered line address step W_{E}, and a sustain step I₂ are executed sequentially. An erasure step E is executed after the execution of the sustain step I₂ only in the last sub-field SF15.

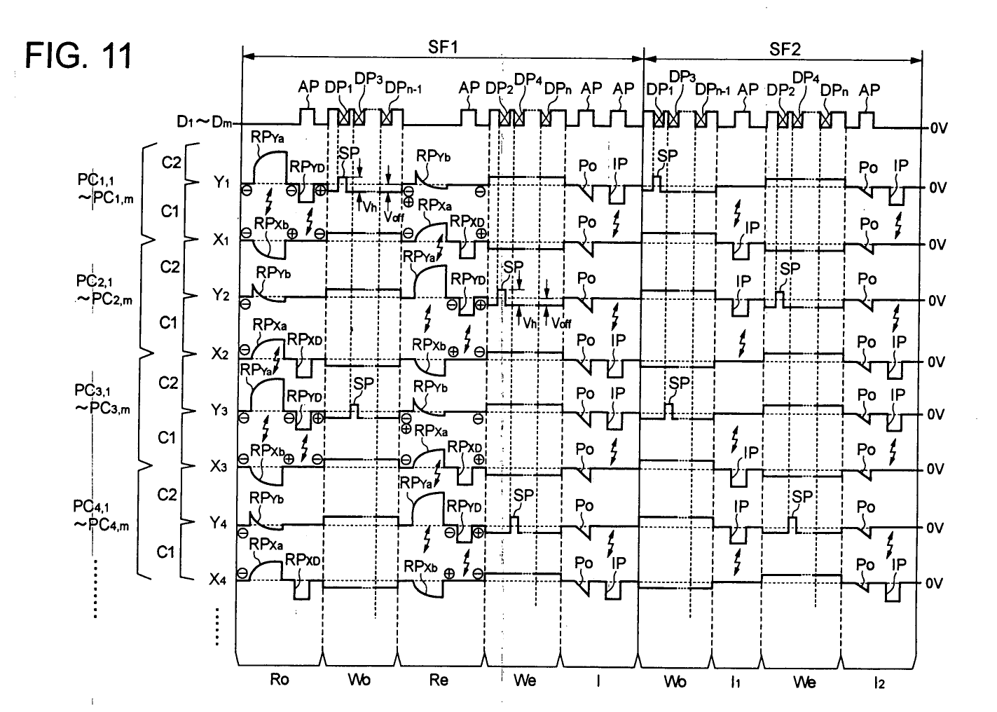

FIG. 11 is a diagram illustrating how the reset sustain drivers 51 and 52, the odd-numbered line scan driver 53, the even-numbered scan line driver 54, and the address driver 55 apply the various drive pulses to the display panel part DPE in the various steps discussed above, for the sub-fields SF1 and SF2 shown in FIG. 10.

First, in the odd-numbered line reset step R_{O}, as shown in FIG. 11, the reset sustain driver 51 generates a positive-polarity reset pulse RP_{Xa} whose voltage has a waveform that rises gently from 0 volts. The reset sustain driver 51 supplies this reset pulse RP_{Xa} to the odd-numbered line scan driver 53, and as shown in FIG. 11, applies it to the even-numbered row electrodes X₂, X₄, X₆, . . . , Xₙ₋₂ and Xₙ of the display panel part DPE. Here, the odd-numbered line scan driver 53 produces a reset pulse RP_{Ya} (shown in FIG. 11) in which the reset pulse RP_{Xa} has been shifted overall by a specific voltage Vₕ to the positive potential side, and applies this to the odd-numbered row electrodes Y₁, Y₃, Y₅, . . . , Yₙ₋₃ and Yₙ₋₁ of the display panel part DPE. Simultaneously with the application of these reset pulses RP_{Xa} and RP_{Ya}, as shown in FIG. 11, the reset sustain driver 52 generates a negative-polarity reset pulse RP_{Xb} whose voltage has a waveform that gently decreases from 0 volts. The reset sustain driver 52 supplies this reset pulse RP_{Xb} to the even-numbered scan line driver 54, and applies it to the odd-numbered row electrodes X₁, X₃, X₅, . . . , Xₙ₋₃ and Xₙ₋₁ of the display panel part DPE as shown in FIG. 11. Here, the even-numbered scan line driver 54 produces a reset pulse RP_{Yb} (shown in FIG. 11) in which the reset pulse RP_{Xb} has been shifted overall by a specific voltage Vₕ to the positive potential side, and applies this to the even-numbered row electrodes Y₂, Y₄, . . . , Yₙ₋₂ and Yₙ of the display panel part DPE.

The application of these reset pulses RP_{Ya}, RP_{Xa}, RP_{Xb}, RP_{Yb} induces a first reset discharge between the odd-numbered row electrodes X and odd-numbered row electrodes Y among the row electrodes X₁ to Xₙ and Y₁ to Yₙ, and between the even-numbered row electrodes X and the odd-numbered row electrodes Y. After this first reset discharge has dissipated, a charge of positive polarity is formed near the row electrodes X in the display cells C1, and a charge of negative polarity near the row electrodes Y.

Also, in the odd-numbered line reset step R_{O}, after the application of the reset pulse RP_{Xa}, the reset sustain driver 51 generates a negative-polarity reset pulse RP_{XD} (as shown in FIG. 11), supplies this to the odd-numbered line scan driver 53, and applies it to the even-numbered row electrodes X₂, X₄, X₆, . . . , Xₙ₋₂ and Xₙ. Here, the odd-numbered line scan driver 53 applies a reset pulse RP_{YD} of the same waveform as the reset pulse RP_{XD} to the odd-numbered row electrodes Y₁, Y₃, Y₅, . . . , Yₙ₋₃ and Yₙ₋₁ at the same timing as this reset pulse RP_{XD}. Further, during this period the address driver 55 applies an auxiliary pulse AP of positive polarity (as shown in FIG. 11) to the column electrodes D₁ to Dₘ of the display panel part DPE. A second reset discharge is induced between the row electrodes X and Y in the various display cells C1 of the pixel cells PC belonging to odd-numbered display lines among the pixel cells PC_{1,1} to PC_{n,m}, according to the application of the above-mentioned reset pulse RP_{YD}. After this second reset discharge has dissipated, a charge of negative polarity is formed near the row electrodes X in the display cells C1, and a charge of positive polarity near the row electrodes Y. Furthermore, while the reset pulse RP_{YD} is being applied, the reset pulse RP_{XD} of the same polarity as this reset pulse RP_{YD} is applied to each of the even-numbered row electrodes X, so the second reset discharge is not induced between the odd-numbered row electrodes Y and the even-numbered row electrodes X, that is, within the selection cells C2 of the various pixel cells PC belonging to the odd-numbered display lines.

As discussed above, in the odd-numbered line reset step R_{O}, all of the pixel cells PC belonging to the odd-numbered display lines are initialized in a flashing cell mode in which a so-called wall charge is formed, wherein a charge of negative polarity remains near the row electrodes X and a charge of positive polarity near the row electrodes Y in the display cells C1.

Next, in the odd-numbered line address step W_{O}, the reset sustain driver 52 applies pulses of positive polarity that maintain a specific positive voltage state throughout the execution of this odd-numbered line address step W_{O}, to the odd-numbered row electrodes X₁, X₃, X₅, . . . Xₙ₋₃ and Xₙ₋₁. During this time, the even-numbered scan line driver 54 applies pulses of positive polarity that maintain a specific positive voltage state to the even-numbered row electrodes Y₂, Y₄, . . . Yₙ₋₂ and Yₙ. Also, in this odd-numbered line address step W_{O}, the reset sustain driver 51 applies pulses of negative polarity that maintain the voltage state (−V_{off}) throughout the execution of this odd-numbered line address step W_{O}, to the even-numbered row electrodes X₂, X₄, X₆, . . . Xₙ₋₂ and Xₙ. Also, in the odd-numbered line address step W_{O}, the odd-numbered line scan driver 53 applies pulses of negative polarity that maintain the voltage state (−V_{off}) throughout the execution of this odd-numbered line address step W_{O}, to the odd-numbered row electrodes Y₁, Y₃, Y₅, . . . , Yₙ₋₃ and Yₙ₋₁. Also, the odd-numbered line scan driver 53 superimposes the scanning pulse SP shown in FIG. 11, the pulse amplitude of which becomes the specific voltage Vₕ, over a pulse of negative polarity that maintains the voltage state (−V_{off}), and sequentially applies it to the odd-numbered row electrodes Y₁, Y₃′ Y₅′ . . . , Yₙ₋₃ and Yₙ₋₁ Furthermore, in the odd-numbered line address step W_{O}, the address driver 55 converts the pixel drive data bits corresponding to the odd-numbered display lines in the pixel drive data bit group DB1 corresponding to the sub-field SF1 into a pixel data pulse DP having a pulse voltage corresponding to the logic level of each bit. For instance, the address driver 55 converts a pixel drive data bit with a logic level of 0 into a high-voltage pixel data pulse DP of positive polarity, but converts a pixel drive data bit with a logic level of 1 into a low-voltage (O volt) pixel data pulse DP. These pixel data pulses DP are synchronized with the timing of application of the above-mentioned scanning pulses SP and are applied to the column electrodes D₁ to Dₘ one display line (m number) at a time. In other words, the address driver 55 first applies the pixel data pulse group DP₁ composed of m-number of pixel data pulses DP corresponding to the first display line to the column electrodes column electrodes D₁ to Dₘ, then applies the pixel data pulse group DP₃ composed of m-number of pixel data pulses DP corresponding to the third display line to the column electrodes D₁ to Dₘ. Here, an erasure address discharge is induced in the selection cells C2 of the pixel cells PC to which the low-voltage (0 volt) pixel data pulses DP have been applied simultaneously with the scanning pulses SP. Meanwhile, the erasure address discharge is not induced in the selection cells C2 of the pixel cells PC to which the high-voltage pixel data pulses DP have been applied simultaneously with the scanning pulses SP. This results in an unlit cell mode in which the so-called wall charge has been eliminated, wherein a negative charge is formed near the row electrodes Y in the selection cells C2 in which the erasure address discharge was induced, and a negative charge remains near the row electrodes X. Meanwhile, since there is no change in the charge formation state in the selection cells C2 in which the erasure address discharge was not induced, the immediately prior state (flashing cell mode or unlit cell mode) is maintained.

As discussed above, in the odd-numbered line address step W_{O}, the selection cells C2 of pixel cells PC belonging to odd-numbered display lines are set to either a flashing cell mode or unlit cell mode on the basis of the pixel data corresponding to the input video signal.

In the even-numbered line reset step Rₑ, as shown in FIG. 11, the reset sustain driver 52 generates a reset pulse RP_{Xa} of positive polarity has a waveform that rises gently from 0 volts. The reset sustain driver 52 supplies this reset pulse RP_{Xa} to the even-numbered scan line driver 54, and as shown in FIG. 11, applies it to the odd-numbered row electrodes X₁, X₃, X₅, . . . , Xₙ₋₃ and Xₙ₋₁ of the display panel part DPE. Here, the even-numbered scan line driver 54 produces a reset pulse RP_{Ya} (shown in FIG. 11) in which the reset pulse RP_{Xa} has been shifted overall by a specific voltage Vₕ to the positive potential side, and applies this to the even-numbered row electrodes Y₂, Y₄, . . . , Yₙ₋₂ and Yₙ of the display panel part DPE. Simultaneously with the application of these reset pulses RP_{Xa} and RP_{Ya}, as shown in FIG. 11, the reset sustain driver 51 generates a negative-polarity reset pulse RP_{Xb} whose voltage has a waveform that gently decreases from 0 volts. The reset sustain driver 51 supplies this reset pulse RP_{Xb} to the odd-numbered line scan driver 53, and applies it to the even-numbered row electrodes X₂, X₄, X₆, . . . , Xₙ₋₂ and Xₙ of the display panel part DPE as shown in FIG. 11. Here, the odd-numbered line scan driver 53 produces a reset pulse RP_{Yb} (shown in FIG. 11) in which the reset pulse RP_{Xb} has been shifted overall by a specific voltage Vₕ to the positive potential side, and applies this to the odd-numbered row electrodes Y₁, Y₃, Y₅, . . . , Yₙ₋₃ and Yₙ₋₁ of the display panel part DPE.

The application of these reset pulses RP_{Ya}, RP_{Xa}, RP_{Xb}, RP_{Yb} induces a first reset discharge between the even-numbered row electrodes X and even-numbered row electrodes Y among the row electrodes X₁ to Xₙ and Y₁ to Yₙ, and between the odd-numbered row electrodes X and the even-numbered row electrodes Y. Specifically, a first reset discharge is induced in the display cells C1 and the selection cells C2 of the pixel cells PC belonging to the even-numbered display lines among the pixel cells PC_{1,1} to PC_{n,m}. After this first reset discharge has dissipated, a charge of positive polarity is formed near the row electrodes X in the display cells C1, and a charge of negative polarity near the row electrodes Y.

In the even-numbered line reset step Rₑ, after the application of the reset pulse RP_{Xa}, the reset sustain driver 52 generates a reset pulse RP_{XD} of negative polarity as shown in FIG. 11, supplies this to the even-numbered scan line driver 54, and applies it to the odd-numbered row electrodes X₁, X₃, X₅, . . . , Xₙ₋₃ and Xₙ₋₁. Here, the even-numbered scan line driver 54 applies a reset pulse RP_{YD} Of the same waveform as the reset pulse RP_{XD} to the even-numbered row electrodes Y₂, Y₄, . . . , Yₙ₋₂ and Yₙ at the same timing as this reset pulse RP_{XD}. Further, during this period the address driver 55 applies an auxiliary pulse AP of positive polarity (as shown in FIG. 11) to the column electrodes D₁ to Dₘ of the display panel part DPE. A second reset discharge is induced between the row electrodes X and Y in the various display cells C1 of the pixel cells PC belonging to even-numbered display lines among the pixel cells PC_{1,1} to PC_{n,m}, according to the application of the above-mentioned reset pulse RP_{YD}. After this second reset discharge has dissipated, a charge of negative polarity is formed near the row electrodes X in the display cells C1, and a charge of positive polarity near the row electrodes Y. Furthermore, while the reset pulse RP_{YD} is being applied, the reset pulse RP_{XD} of the same polarity as this reset pulse RP_{YD} is applied to each of the odd-numbered row electrodes X, so the second reset discharge is not induced between the even-numbered row electrodes Y and the odd-numbered row electrodes X, that is, within the selection cells C2 of the various pixel cells PC belonging to the even-numbered display lines.

As discussed above, in the even-numbered line reset step Rₑ, all of the pixel cells PC belonging to the even-numbered display lines are initialized in a flashing cell mode in which a so-called wall charge is formed, wherein a charge of negative polarity remains near the row electrodes X and a charge of positive polarity near the row electrodes Y in the display cells C1.

Next, in the even-numbered line address step W_{E}, the reset sustain driver 51 applies pulses of positive polarity that maintain a specific positive voltage state throughout the execution of this even-numbered line address step Wₑ, to the even-numbered row electrodes X₂, X₄, X₆, . . . Xₙ₋₂ and Xₙ. During this time, the odd-numbered scan line driver 53 applies pulses of positive polarity that maintain a specific positive voltage state to the odd-numbered row electrodes Y₁, Y₃, Y₅, . . . , Yₙ₋₃ and Yₙ₋₁. Also, in this even-numbered line address step Wₑ, the reset sustain driver 52 applies pulses of negative polarity that maintain the voltage state (−V_{off}) throughout the execution of this even-numbered line address step Wₑ, to the odd-numbered row electrodes X₁, X₃, X₅, . . . , Xₙ₋₃ and Xₙ₋₁. Also, in the even-numbered line address step Wₑ, the even-numbered line scan driver 54 applies pulses of negative polarity that maintain the voltage state (−V_{off}) throughout the execution of this even-numbered line address step Wₑ, to the even-numbered row electrodes Y₂, Y₄, . . . , Yₙ₋₂ and Yₙ. Also, the even-numbered line scan driver 54 superimposes the scanning pulse SP shown in FIG. 11, the pulse amplitude of which becomes the specific voltage Vₕ, over a pulse of negative polarity that maintains the voltage state (−V_{off}), and sequentially applies it to the even-numbered row electrodes Y₂, Y₄, . . . , Yₙ₋₂ and Yₙ. Furthermore, in the even-numbered line address step Wₑ, the address driver 55 converts the pixel drive data bits corresponding to the even-numbered display lines in the pixel drive data bit group DB1 corresponding to the sub-field SF1 into a pixel data pulse DP having a pulse voltage corresponding to the logic level of each bit. For instance, the address driver 55 converts a pixel drive data bit with a logic level of 0 into a high-voltage pixel data pulse DP of positive polarity, but converts a pixel drive data bit with a logic level of 1 into a low-voltage (0 volt) pixel data pulse DP. These pixel data pulses DP are synchronized with the timing of application of the above-mentioned scanning pulses SP and are applied to the column electrodes D₁ to Dₘ one display line (m number) at a time. In other words, the address driver 55 first applies the pixel data pulse group DP₂ composed of m-number of pixel data pulses DP corresponding to the second display line to the column electrodes column electrodes D₁ to Dₘ, then applies the pixel data pulse group DP₄ composed of m-number of pixel data pulses DP corresponding to the fourth display line to the column electrodes D₁ to Dₘ. Here, an erasure address discharge is induced in the selection cells C2 of the pixel cells PC to which the low-voltage (0 volt) pixel data pulses DP have been applied simultaneously with the scanning pulses SP. Meanwhile, the erasure address discharge is not induced in the selection cells C2 of the pixel cells PC to which the high-voltage pixel data pulses DP have been applied simultaneously with the scanning pulses SP. This results in an unlit cell mode in which the so-called wall charge has been eliminated, wherein a negative charge is formed near the row electrodes Y in the selection cells C2 in which the erasure address discharge was induced, and a negative charge remains near the row electrodes X. Meanwhile, since there is no change in the charge formation state in the selection cells C2 in which the erasure address discharge was not induced, the immediately prior state (flashing cell mode or unlit cell mode) is maintained.

As discussed above, in the even-numbered line address step Wₑ, the selection cells C2 of pixel cells PC belonging to even-numbered display lines are set to either a flashing cell mode or unlit cell mode on the basis of the pixel data corresponding to the input video signal.

Next, in the sustain step I, the reset sustain drivers 51 and 52, the odd-numbered line scan driver 53, and the even-numbered scan line driver 54 all simultaneously supply the discharge expanded pulses P_{O} of negative polarity shown in FIG. 11 to all of the row electrodes X₁ to Xₙ and Y₁ to Yₙ of the display panel part DPE. During this time, the address driver 55 applies the auxiliary pulses AP of positive polarity shown in FIG. 11 to the column electrodes D₁ to Dₘ. Discharge is induced between the column electrodes and row electrodes in the selection cells C2 of the pixel cells PC according to the application of the discharge expanded pulses P_{O} and the auxiliary pulses AP, and this discharge is expanded in the display cells C1 via the gap r in the pixel cells PC. As a result, the state of the selection cells C2 (flashing cell mode or unlit cell mode) moves to the display cell C1 side. After the application of the above-mentioned discharge expanded pulses P_{O}, the reset sustain driver 51 generates a sustain pulse IP of negative polarity as shown in FIG. 11, and along with the odd-numbered line scan driver 53 applies this to the even-numbered row electrodes X₂, X₄, X₆, . . . , Xₙ₋₂ and Xₙ of the display panel part DPE. Here, the odd-numbered line scan driver 53 simultaneously applies this sustain pulse IP to the odd-numbered row electrodes Y₁, Y₃′ Y₅′ . . . , and Yₙ₋₃ and Yₙ₋₁ of the display panel part DPE. During this time, the address driver 55 applies an auxiliary pulse AP of positive polarity to the column electrodes D₁ to Dₘ as shown in FIG. 11.

A sustain discharge is induced between the transparent electrodes Xa and Ya in the display cells C1 in those pixel cells PC set to the above-mentioned flashing cell mode, out of all the pixel cells PC, according to the application of the above-mentioned sustain pulse IP. Here, the ultraviolet rays generated by this sustain discharge excite the fluorescent layer 16 (red fluorescent layer, green fluorescent layer, and blue fluorescent layer) formed in the display cells C1, and light corresponding to these fluorescent colors is radiated out through the front transparent substrate 10.

Next, in the odd-numbered line address step W_{O} of the second sub-field SF2, the reset sustain drivers 51 and 52, the odd-numbered line scan driver 53, and the even-numbered scan line driver 54 sequentially apply scanning pulses SP to the odd-numbered row electrodes Y₁, Y₃, Y₅, . . . , Yₙ₋₃ and Yₙ₋₁ in the same manner as in the odd-numbered line address step W_{O} of SF1 above. The address driver 55 converts the pixel drive data bits corresponding to the odd-numbered display lines in the pixel drive data bit group DB2 corresponding to the sub-field SF2 into a pixel data pulse DP having a pulse voltage corresponding to the logic level of each bit, and applies this to the column electrodes D₁ to Dₘ one display line (m number) at a time in synchronization with the application timing of the scanning pulses SP.

In the odd-numbered line address step W_{O} of the second sub-field SF2, just as with SF1, an erasure address discharge is induced in the pixel cells PC to which the low-voltage (0 volt) pixel data pulses DP have been applied simultaneously with the scanning pulses SP. Meanwhile, the erasure address discharge is not induced in the pixel cells PC to which the high-voltage pixel data pulses DP have been applied simultaneously with the scanning pulses SP. Here, those pixel cells PC in which the erasure address discharge was induced are set to unlit cell mode, while those pixel cells PC in which the erasure address discharge was not induced maintain the immediately prior state (flashing cell mode or unlit cell mode).

Next, in the sustain step I₁ of sub-field SF2, the address driver 55 applies an auxiliary pulse AP of positive polarity (as shown in FIG. 11) to the column electrodes D₁ to Dₘ. Simultaneously with the application of this auxiliary pulse AP, the reset sustain driver 52 generates the sustain pulse IP as shown in FIG. 11, and along with the even-numbered scan line driver 54 applies this to the odd-numbered row electrodes X of the display panel part DPE. Here, the even-numbered scan line driver 54 simultaneously applies this sustain pulse IP to the even-numbered row electrodes Y of the display panel part DPE. A sustain discharge is induced between the transparent electrodes Xa and Ya in the display cells C1 in those pixel cells PC set to the above-mentioned flashing cell mode, out of all the pixel cells PC, according to the application of the above-mentioned sustain pulse IP. Here, the ultraviolet rays generated by this sustain discharge excite the fluorescent layer 16 (red fluorescent layer, green fluorescent layer, and blue fluorescent layer) formed in the display cells C1, and light corresponding to these fluorescent colors is radiated out through the front transparent substrate 10.

Next, in the even-numbered line address step Wₑ of the second sub-field SF2, the reset sustain drivers 51 and 52, the odd-numbered line scan driver 53, and the even-numbered scan line driver 54 sequentially apply scanning pulses SP to the even-numbered row electrodes Y₂, Y₄, . . . , Yₙ₋₂ and Yₙ in the same manner as in the even-numbered line address step Wₑ of SF1 above. During this time, the address driver 55 converts the pixel drive data bits corresponding to the even-numbered display lines in the pixel drive data bit group DB2 corresponding to the sub-field SF2 into a pixel data pulse DP having a pulse voltage corresponding to the logic level of each bit, and applies this to the column electrodes D₁ to Dₘ one display line (m number) at a time in synchronization with the application timing of the scanning pulses SP.

In the even-numbered line address step We of the second sub-field SF2, just as with SF1, an erasure address discharge is induced in the pixel cells PC to which the low-voltage (0 volt) pixel data pulses DP have been applied simultaneously with the scanning pulses SP. Meanwhile, the erasure address discharge is not induced in the pixel cells PC to which the high-voltage pixel data pulses DP have been applied simultaneously with the scanning pulses SP. Here, those pixel cells PC in which the erasure address discharge was induced are set to unlit cell mode, while those pixel cells PC in which the erasure address discharge was not induced maintain the immediately prior state (flashing cell mode or unlit cell mode).

Next, in the sustain step I₂ of sub-field SF2, the reset sustain drivers 51 and 52, the odd-numbered line scan driver 53, and the even-numbered scan line driver 54 all simultaneously supply the discharge expanded pulses P_{O} of positive polarity shown in FIG. 11 to all of the row electrodes X₁ to Xₙ and Y₁ to Yₙ of the display panel part DPE. During this time, the address driver 55 applies the auxiliary pulses AP of positive polarity shown in FIG. 11 to the column electrodes D₁ to Dₘ. After the application of the above-mentioned discharge expanded pulses P_{O}, the reset sustain driver 51 generates a sustain pulse IP of negative polarity as shown in FIG. 11, and along with the odd-numbered line scan driver 53 applies this to the even-numbered row electrodes X₂, X₄, X₆, . . . , Xₙ₋₂ and Xₙ of the display panel part DPE. Here, the odd-numbered line scan driver 53 simultaneously applies this sustain pulse IP to the odd-numbered row electrodes Y₁, Y₃, Y₅′ . . . , Yₙ₋₃ and Yₙ₋₁ of the display panel part DPE. A sustain discharge is induced between the transparent electrodes Xa and Ya in the display cells C1 in those pixel cells PC set to the above-mentioned flashing cell mode, out of all the pixel cells PC, according to the application of the above-mentioned sustain pulse IP. Here, the ultraviolet rays generated by this sustain discharge excite the fluorescent layer 16 (red fluorescent layer, green fluorescent layer, and blue fluorescent layer) formed in the display cells C1, and light corresponding to these fluorescent colors is radiated out through the front transparent substrate 10.

When drive is executed as shown in FIGS. 10 and 11 on the basis of the 16 sets of pixel drive data GD shown in FIG. 9, during the display period of one frame, erasure address discharge (indicated by solid black circles in FIG. 9) is induced in the address steps (W_{O} and Wₑ) of the respective sub-fields that are continuous by an amount corresponding to the intermediate brightness to be expressed. Specifically, the pixel cells PC are set to flashing cell mode at the various sub-fields that are continuous by an amount corresponding to the intermediate brightness to be expressed, and perform sustain discharge (indicated by the non-solid circles in FIG. 9) in continuation with the sustain step I of each of the sub-fields. Here, the visible brightness corresponds to the total number of sustain discharges induced within the period of one frame display. Specifically, with the 16 different light emission patterns provided by the first to sixteenth gradation drives shown in FIG. 9, intermediate brightness of 16 gradations appears corresponding to the total number of sustain discharges induced in the sub-fields indicated by the non-solid circles.

As discussed above, with the plasma display device shown in FIG. 4, the pixel cells PC that serve as the pixel cells of the PDP 50 are made up of the display cells C1 and the selection cells C2 as shown in FIGS. 5 and 6. A secondary electron releasing material layer 30 is provided as shown in FIG. 6 on the back substrate 13 side in the selection cells C2. The secondary electron releasing material layer 30 has good gamma characteristics for releasing secondary electrons during discharge when the side on which this layer is formed is used as a cathode. Here, in the address steps (W_{O} and Wₑ) shown in FIG. 11, address discharge is induced by applying scanning pulses SP of positive polarity to the row electrodes Y, and applying low-voltage (0 volt) pixel data pulses DP to the column electrodes D. Specifically, the address discharge is induced with the column electrodes D on the cathode side. Therefore, the secondary electron releasing material layer 30 formed in the selection cells C2 also becomes a cathode, secondary electrons are released favorably from this secondary electron releasing material layer 30, and address discharge is reliably induced in the selection cells C2.

With the PDP 50 shown in FIG. 4, the connection terminal T_{XO} to which the odd-numbered row electrodes X₁, X₃, . . . , Xₙ₋₃ and Xₙ₋₁ are connected in common is provided to the right end of the display panel part DPE, and a connection terminal T_{XE} to which the even-numbered row electrodes X₂, X₄, . . . , Xₙ₋₂ and Xₙ are connected in common is provided to the left end of the display panel part DPE. Connection terminals T_{Y1}, T_{Y3}, . . . , T_{Y(n-1)} to which the odd-numbered row electrodes Y₁, Y₃, Y₅, . . . , Yₙ₋₃ and Yₙ₋₁ are connected individually are provided to the left end of the display panel part DPE, and connection terminals T_{Y2}, T_{Y4}, . . . , T_{Y(n)} to which the even-numbered row electrodes Y₂, Y₄, . . . , Yₙ₋₂ and Yₙ are connected individually are provided to the right end of the display panel part DPE. Here, the reset sustain driver 51 and the odd-numbered line scan driver 53 are mounted near the left end of the display panel part DPE on the chassis supporting the display panel part DPE, and are electrically connected to the connection terminal T_{XE} and the connection terminals T_{Y1}, T_{Y3}, . . . ,T_{Y(n-1)} provided to the left end of the display panel part DPE. Further, the reset sustain driver 52 and the even-numbered scan line driver 54 are mounted near the right end of the display panel part DPE on the chassis, and are electrically connected to the connection terminal T_{XO} and the connection terminals T_{Y2}, T_{Y4}, . . . , T_{Y(n)} provided to the right end of the display panel part DPE.

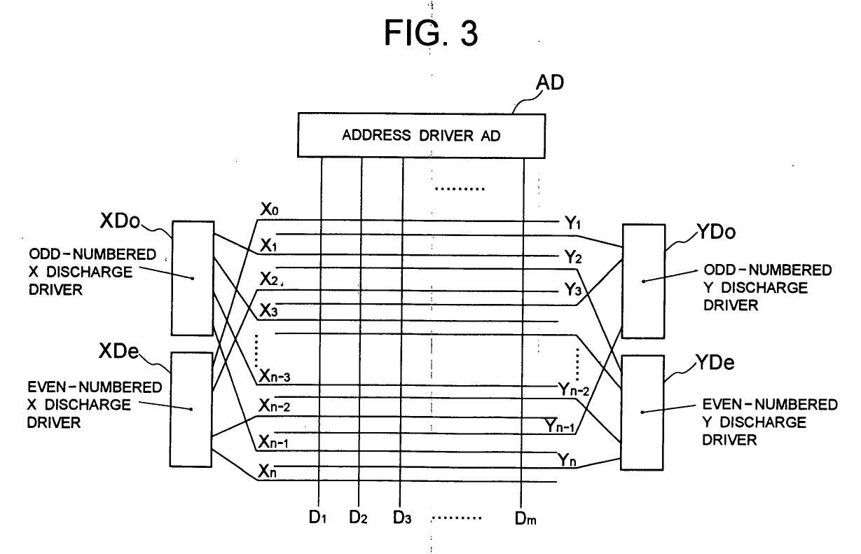

With the structure described above, there are fewer places of intersection in the wiring that electrically connects each of the odd-numbered line scan driver 53, an odd-numbered Y electrode driver 53a, the even-numbered scan line driver 54, and an even-numbered Y electrode driver 53b with the display panel part DPE, as compared to when the structure shown in FIG. 3 is employed. Thus, with a wiring configuration such as this, less stray capacity is present between wires, and this decreases the consumption of reactive power that accompanies reactive charging and discharging with respect to this stray capacity. Furthermore, there is a decrease in the probability that problems such as migration or withstand voltage failure will occur between the connection terminals of row electrodes belonging to odd-numbered display lines and the connection terminals of row electrodes belonging to even-numbered display lines.

Further, in the present invention, the reset discharge used to initialize the state of the pixel cells PC (put them in flashing cell mode) is executed at different times between the pixel cells PC belonging to odd-numbered display lines and the pixel cells PC belonging to even-numbered display lines. Thus, when reset discharge is induced by applying reset pulses of different polarity to the row electrodes X and Y, there will be no accidental discharge, and it will be possible to apply reset pulses of the same polarity to row electrodes Y (row electrodes X) belonging to both odd-numbered and even-numbered display lines. As a result, the polarity of the charges formed near the row electrodes X and Y can be the same after dissipation of the reset discharge for both odd- and even-numbered display lines, so there is no need to induce a new discharge for aligning the polarities.

With the drive shown in FIG. 11, when a reset discharge is induced in the pixel cells PC belonging to an odd-numbered display line group (odd-numbered line reset step R_{O}), a reset pulse RP_{Xa} of positive polarity is applied to the even-numbered row electrodes X, and a reset pulse RP_{Xb} of negative polarity is applied to the odd-numbered row electrodes X. Further, a reset pulse RP_{Ya} in which the reset pulse RP_{Xa} has been shifted by a specific voltage Vₕ to the positive potential side is applied to the odd-numbered row electrodes Y, and a reset pulse RP_{Yb} in which the reset pulse RP_{Xb} has been shifted by a specific voltage Vₕ to the positive potential side is applied to the even-numbered row electrodes Y. Also, when a reset discharge is induced in the pixel cells PC belonging to an even-numbered display line group (even-numbered line reset step RE), the reset pulse RP_{Xa} is applied to the odd-numbered row electrodes X, the reset pulse RP_{Xb} is applied to the even-numbered row electrodes X, the reset pulse RP_{Ya} is applied to the odd-numbered row electrodes Y, and the reset pulse RP_{Yb} is applied to the odd-numbered row electrodes Y.

Thus, with the drive shown in FIG. 11, voltage comprising (RP_{Ya}−RP_{Xb}) is applied between the row electrodes X and Y of the pixel cells PC that are to undergo reset discharge, and voltage comprising (RP_{Xa}−RP_{Yb}) is applied between the row electrodes X and Y of the pixel cells PC that are not to undergo reset discharge. Here, the reset pulse RP_{Ya} is the product of shifting the reset pulse RP_{Xa} of positive polarity by the specific voltage Vₕ to the positive potential side. This creates a potential difference of 2·Vₕ between the voltage applied between the row electrodes X and Y of the pixel cells PC that are to undergo reset discharge and the voltage applied between the row electrodes X and Y of the pixel cells PC that are not to undergo reset discharge. This potential difference of ²·Vₕ makes it possible for reset discharge to be reliably induced in the pixel cells PC that are to undergo reset discharge, and for accidental discharge to be reliably prevented in the pixel cells PC that are not to undergo reset discharge.

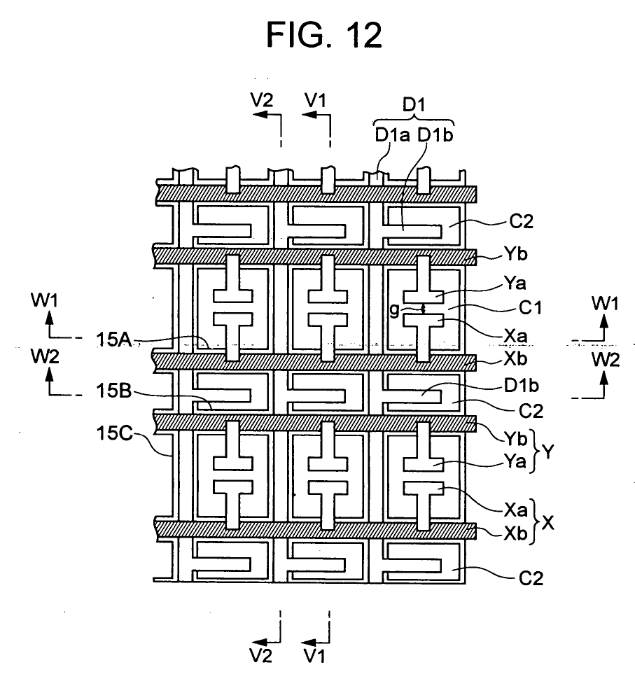

In the above embodiment, the structure shown in FIGS. 5 to 8 was employed as the pixel cell PC, but the structure shown in FIGS. 12 to 16, for example, may be employed instead.

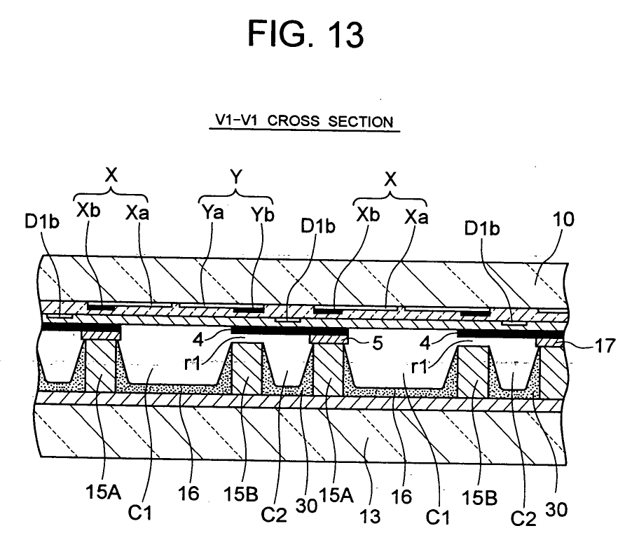

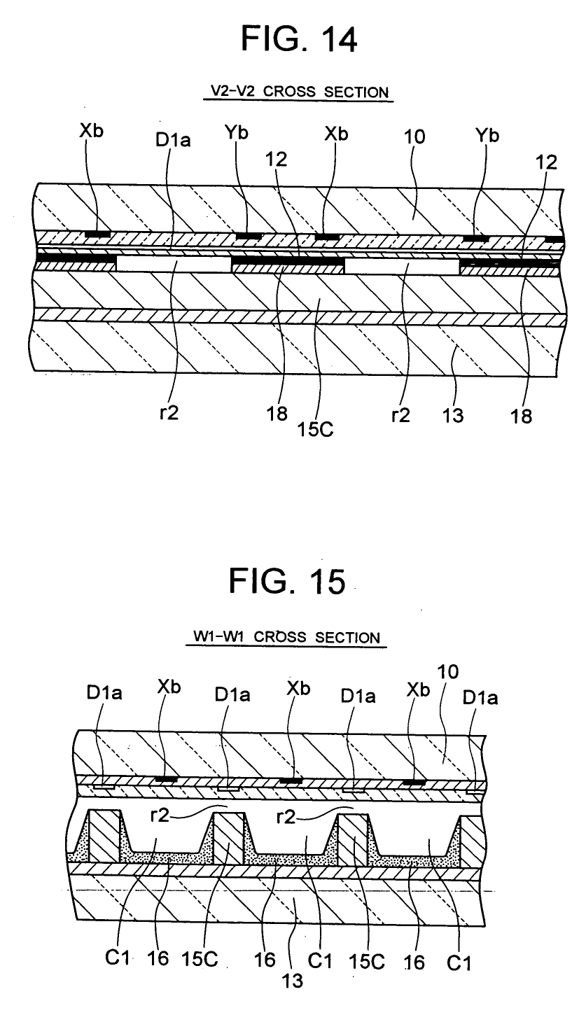

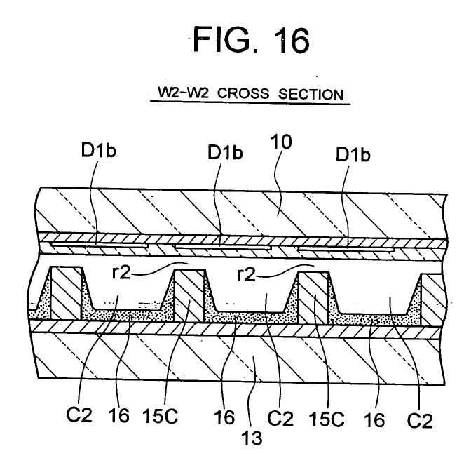

FIG. 12 is a plan view of the display panel part DPE of the PDP 50 from the display screen side. FIG. 13 is a cross section along the V1-V1 line in FIG. 12. FIG. 14 is a cross section along the V2-V2 line in FIG. 12. FIG. 15 is a cross section along the W1-W1 line in FIG. 12. FIG. 16 is a cross section along the W2-W2 line in FIG. 12.

In FIGS. 12 to 16, those components that are the same as the components shown in FIGS. 5 to 8 are numbered the same.

With the structure shown in FIGS. 12 to 16, the column electrodes D are provided on the front transparent substrate 10 side along with the row electrodes X and Y. As shown in FIG. 12, each column electrode D is made up of a band-shaped main electrode part D1a extending in the column direction (up and down) of the display screen, and a protruding electrode part D1b protruding from the main electrode part in the row direction (left and right) of the display screen in each selection cell C2. Each of the main electrode parts D1a is disposed superposed over a vertical wall 15C as shown in FIG. 15, and reset discharge and address discharge are induced between this main electrode part D1a and the bus electrode Yb in the selection cell C2.

Also, the above embodiment was of application to a PDP having a cell structure whose unit light emission region was made up of a display cell C1 (first discharge cell) and a selection cell C2 (second discharge cell), but the structure of the PDP is limited to this structure. For instance, it is also possible to use a PDP having a structure in which the row electrodes X and Y that constitute the display lines have discharge polarity and directionality, and this polarity and directionality are oriented in the same direction for all of the display lines of the even-numbered display lines and odd-numbered display lines (for example, a structure in which row electrodes X to which sustain pulses are applied and row electrodes Y to which sustain pulses and scanning pulses are applied are laid out in an alternating pattern).

This application is based on Japanese Patent Application No. 2004-220135 which is hereby incorporated by reference.

What is claimed is:

1. A display device, comprising a display panel having formed therein a plurality of first and second row electrode lines disposed alternatingly and each extending in the horizontal direction of a display screen between a pair of substrates disposed across from each other with a discharge space therebetween, a plurality of column electrode lines disposed so as to intersect the first and second row electrode lines, and pixel cells for carrying pixels, provided at the intersections between the first and second row electrode lines and the column electrode lines,
wherein the display device comprises a reset component for initializing the state of each of the pixel cells by inducing a reset discharge in all of the pixel cells, an address component for setting each of the pixel cells to either a flashing mode or an unlit mode by selectively subjecting the pixel cells to address discharge by sequentially applying scanning pulses to each of the first row electrode lines and applying pixel data pulses corresponding to input video signals to the column electrode lines, and a sustain component for subjecting only those pixel cells that are in the flashing mode to sustain discharge by applying sustain pulses to the first row electrode lines or the second row electrode lines,
a plurality of first connection terminals connected individually to each of the first row electrode lines disposed at odd-numbered locations among the first row electrode lines, and a single second connection terminal connected in common to each of the second row electrode lines disposed at even-numbered locations among the second row electrode lines are provided in the vicinity of one side of the display panel, and a plurality of third connection terminals connected individually to each of the first row electrode lines disposed at even-numbered locations among the first row electrode lines, and a single fourth connection terminal connected in common to each of the second row electrode lines disposed at odd-numbered locations among the second row electrode lines are provided in the vicinity of the other side of the display panel,
the address component includes a first scan driver for sequentially applying the scan pulses to each of the first connection terminals, and a second scan driver for sequentially applying the scan pulses to each of the third connection terminals,
the sustain component includes a first sustain driver for simultaneously applying the sustain pulses to the first connection terminals and the second connection terminal, and a second sustain driver for simultaneously applying the sustain pulses to the third connection terminals and the fourth connection terminal,
the reset component includes a first reset driver for simultaneously applying first reset pulses having a first polarity or second reset pulses having a second polarity different from the first polarity to each of the second row electrode lines disposed at even-numbered locations, and simultaneously applying third reset pulses having a pulse voltage that is higher by a specific voltage than the voltage of the first reset pulses, or fourth reset pulses having a pulse voltage that is higher by a specific voltage than the voltage of the second reset pulses to each of the first row electrode lines disposed at odd-numbered locations, and a second reset driver for simultaneously applying the second reset pulses or the first reset pulses to each of the second row electrode lines disposed at odd-numbered locations, and simultaneously applying the fourth reset pulses or the third reset pulses to each of the first row electrode lines disposed at even-numbered locations, and
the display device further comprises a drive control component for controlling the first and second reset drivers such that the reset discharge induced in each of the pixel cells belonging to the first and second row electrode lines disposed at odd-numbered locations, and the reset discharge induced in each of the pixel cells belonging to the first and second row electrode lines disposed at even-numbered locations are executed at different times.

2. The display device according to claim 1, wherein within a first reset period the drive control component induces the reset discharge in each of the pixel cells belonging to the first and second row electrode lines disposed at odd-numbered locations by controlling the first reset driver such that the first reset pulses are simultaneously applied to each of the second row electrode lines disposed at even-numbered locations and the third reset pulses are simultaneously applied to each of the first row electrode lines disposed at odd-numbered locations, and by controlling the second reset driver such that the second reset pulses are simultaneously applied to each of the second row electrode lines disposed at odd-numbered locations and the fourth reset pulses are simultaneously applied to each of the first row electrode lines disposed at even-numbered locations, and
within a second reset period the drive control component induces the reset discharge in each of the pixel cells belonging to the first and second row electrode lines disposed at even-numbered locations by controlling the first reset driver such that the second reset pulses are simultaneously applied to each of the second row electrode lines disposed at even-numbered locations and the fourth reset pulses are simultaneously applied to each of the first row electrode lines disposed at odd-numbered locations, and by controlling the second reset driver such that the first reset pulses are simultaneously applied to each of the second row electrode lines disposed at odd-numbered locations and the third reset pulses are simultaneously applied to each of the first row electrode lines disposed at even-numbered locations.

3. The display device according to claim 1, wherein the drive control component controls the first and second reset drivers so as to induce the reset discharge at the beginning of each frame display period.

4. The display device according to claim 1, wherein the pixel cells each comprise a display cell and a selection cell in which a light absorption layer is provided on the front side of the substrate.

5. The display device according to claim 1, wherein the address component sets the display cells to either a flashing mode or an unlit mode by inducing the address discharge within the selection cell and expanding the discharge to the display cell side.

6. The display device according to claim 4, wherein the address component sets the display cells to either a flashing mode or an unlit mode by inducing the address discharge within the selection cell and expanding the discharge to the display cell side.

7. The display device according to claim 1, wherein the display cells each include a portion in which the first and second row electrode that form a pair are facing each other across a first discharge gap within the discharge space, and
the selection cells each include a portion in which the column electrode and the first row electrode are facing each other across a second discharge gap in the discharge space.

8. The display device according to claim 4, wherein the display cells each include a portion in which the first and second row electrode that form a pair are facing each other across a first discharge gap within the discharge space, and
the selection cells each include a portion in which the column electrode and the first row electrode are facing each other across a second discharge gap in the discharge space.

9. The display device according to claim 1, wherein the first and second row electrodes each comprise a main part extending in the row direction on the screen, and a protruding part protruding from the main part via a first discharge gap for every pixel cell, in the column direction on the screen, and
the display cells include a portion in which the protruding parts are facing each other across the first discharge gap in the discharge space, and the selection cells include a portion in which the column electrode and the main part of the first row electrode are facing each other across a second discharge gap in the discharge space.

10. The display device according to claim 4, wherein the first and second row electrodes each comprise a main part extending in the row direction on the screen, and a protruding part protruding from the main part via a first discharge gap for every pixel cell, in the column direction on the screen, and
the display cells include a portion in which the protruding parts are facing each other across the first discharge gap in the discharge space, and the selection cells include a portion in which the column electrode and the main part of the first row electrode are facing each other across a second discharge gap in the discharge space.

11. The display device according to claim 1, wherein the display panel has a partition comprising a vertical wall part that divides the discharge space of adjacent pixel cells in the row direction on the screen, and a horizontal wall that divides in the column direction, and a divider wall that divides the discharge space of the selection cells from the discharge space of the display cells within the pixel cells, and
the discharge spaces of the selection cells of the pixel cells are shut off by the partition from the discharge space of adjacent pixel cells, the discharge spaces of the display cells of pixel cells adjacent in the row direction communicate with each other, and the discharge spaces of the selection cells and the discharge spaces of the display cells within the pixel cells communicate with each other.

12. The display device according to claim 4, wherein the display panel has a partition comprising a vertical wall part that divides the discharge space of adjacent pixel cells in the row direction on the screen, and a horizontal wall that divides in the column direction, and a divider wall that divides the discharge space of the selection cells from the discharge space of the display cells within the pixel cells, and
the discharge spaces of the selection cells of the pixel cells are shut off by the partition from the discharge space of adjacent pixel cells, the discharge spaces of the display cells of pixel cells adjacent in the row direction communicate with each other, and the discharge spaces of the selection cells and the discharge spaces of the display cells within the pixel cells communicate with each other.

13. The display device according to claim 1, wherein a fluorescent layer that emits light by discharge is formed only in the display cells.

14. The display device according to claim 4, wherein a fluorescent layer that emits light by discharge is formed only in the display cells.

15. The display device according to claim 1, wherein each of the first to fourth reset pulses has a pulse waveform whose voltage varies gradually over time.
